(19) United States
(12) Patent Application Publication
(10) Pub. No.: US 2010/0094874 A1
(43) Pub. Date: Apr. 15, 2010

(54) Method and an apparatus for retrieving additional information regarding a patient record

(75) Inventors: Martin Huber, Uttenreuth (DE); Alexey Tsymbal, Erlangen (DE); Sonja Zillner, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/457,592

(22) Filed: Jun. 16, 2009

(30) Foreign Application Priority Data
Oct. 15, 2008 (EP) EP08018097

(51) Int. Cl. G06F 17/30

(52) U.S. Cl. 707/740; 707/E17.014

(57) ABSTRACT

A method and an apparatus retrieve additional information regarding a patient record. Applying the subject-matter of the present invention clinical experts, such as doctors, can be provided with domain specific background knowledge, and can, hence, be supported in making decisions regarding the treatment of patients. Said additional information can be structured and visualised, which makes the retrieved information understandable also for persons without advanced knowledge regarding data processing. The retrieval of additional information is accomplished by a comparison of data being stored in the patient record and data being stored in a predefined textual resource, such as a ontology, and an identification of further terms describing attributes of the patient record. This finds application in supporting the diagnosis of patients and healthcare related information retrieval tasks.

### CROSS REFERENCE TO RELATED APPLICATIONS

This application is based on and hereby claims priority to EP Application No. EP08018097 filed on Oct. 15, 2008, the contents of which are hereby incorporated by reference.

### BACKGROUND OF THE INVENTION

Digitized information management has greatly improved clinical practice during the past decades. Much patient data from demographic information to lab results to diagnostic images is now being stored in computerized form. Today, one of the main challenges for clinical information systems is to find, select and present the right information to the clinician from the amount of data that is available. This is a daunting task unless effective filtering, classification and visual aids are available.

Especially in the healthcare sector a variety of knowledge sources is established. Such knowledge sources model domain specific knowledge by, for instance, semantic resources. A semantic resource may comprise a taxonomy, a thesaurus, semantic net and/or an ontology. Furthermore documents and/or sets of notions may represent domain specific knowledge sources. A taxonomy may model domain specific knowledge by nodes and edges. Node labels hereby represent domain specific concepts. Edges establish a hierarchy of the introduced concepts. Such a hierarchy can reflect class-subclass relationships. A thesaurus and/or a semantic net may furthermore introduce richer edge semantics. For instance an edge between two concepts may indicate a synonym relation. Edges may also be freely typed by the author of the knowledge source. A semantic net can also be called a lightweight ontology. Furthermore heavyweight ontologies may be used enabling the author to assign richer semantics and/or constraints to node and/or edge semantics.

Medical ontologies have become the standard for recording and accessing conceptualized biological and medical knowledge. The expressivity of these ontologies goes from concept lists through taxonomies to formal logical theories. In the context of patient information, their application can be the annotation of medical instance data. To exploit the intrinsic higher expressivity of available domain ontologies, commonly known methods do not provide an architecture which allows for reasoning on patient data using OWL-DL ontologies and navigation over the data using modern data and knowledge visualization techniques; where these two components are tightly coupled in a single framework.

Commonly known methods introduce ontology visualization that may help the user display and navigate underlying ontological concepts.

Furthermore, reasoning with ontologies is currently under study in the semantic web field, with biomedicine being one of the application domains. The ability to reason, that is to draw inferences from the existing knowledge to derive new knowledge, can be an important element for modern systems based on ontologies.

Visualization has been used in commonly known methods to facilitate query formulation or to order threads of data in some schematic way, e.g. temporally; to display a data schema or to perform navigation through the data. In particular cases, ontology-based visualization has been used to support queries based on temporal abstractions; to enrich maps with additional geographic information; to reveal multiple levels of abstraction in decision-tree generation and to assist in information mining and to map social networks and communities of common interest. Ontologies have also been used for knowledge discovery without visualization, especially in the integration of heterogeneous scientific repositories.

Commonly known methods are not able to provide a clinician with richer information than the information provided by a patient record. Hence, only methods for data and knowledge navigation and knowledge discovery are known. Commonly known methods do furthermore not consider external knowledge sources.

### SUMMARY

It is therefore one potential object of the present invention to provide a method for retrieving additional information regarding a patient record.

The inventors propose a method for retrieving additional information regarding a patient record, the method comprising the steps of:
Providing a textual resource comprising at least one term and at least one relationship between said terms;
providing the patient record, the patient record comprising at least one term;
identifying at least one term being comprised in the textual resource, which corresponds to a term being comprised in the patient record; and
retrieving further terms being comprised in the textual resource, said further terms holding at least one of said relationships with said at least one identified term being comprised in said textual resource.

A patient record can for instance be a collection of personal data referring to diseases or diagnoses related information of a patient. The patient record may for instance comprise an ID of the patient, an age at diagnosis time and a tumour site. The patient record may, furthermore, comprise attributes which are numeric, categorical, taking values in a finite set of predefined concepts, for example tumour location, which refers to an anatomical region of the human body.

Providing a textual resource and providing the patient record may be accomplished by a look-up in a database, reading out a local or a network memory device and/or by ad-hoc calculation of a textual resource or a patient record.

The textual resource comprises at least one term and at least one relationship between said terms. A term may for instance be an ontological concept. A term may further be a word being comprised in a sentence. Said terms are connected by at least one relationship. The relationship may be formed by an explicit occurrence of the relationship, or be implicitly formed by a relationship of words in a sentence. The relationship may for instance be a super or subclass relationship.

The textual resource may for instance be an ontology, describing domains of the health care sector. An example for such an ontology is the FMA ontology. The FMA ontology is a computer-based knowledge source for biomedical informatics. Specifically, the FMA ontology is a domain ontology that represents a coherent knowledge base of explicit declarative knowledge about human anatomy. The subject-matter of the proposal is not limited to the FMA ontology, as several other textual resources are contrivable.

The patient record comprises typically several terms, the terms indicating diagnosis information. Such a term may for instance be “tumour”, “tumour region”, “cerebellum” or “hypothalamus”.

At least one term being comprised in a textual resource is identified according to an aspect of the proposal, which corresponds to a term being comprised in the patient record. The identification of corresponding terms may be accomplished as a function of a reasoning. Corresponding terms will be identified by the dictionary, which states corresponding terms, by evaluation of the context of each of the terms or by string distance measuring approaches.

Retrieving further terms being comprised in the textual resource can be accomplished by evaluation of relationships being comprised in the textual resource. The textual resource may for instance be visualized by a graph. Retrieving further terms may comprise identification of each edge representing one relationship, the edge may be incident to said identified at least one term. Hence, all nodes being adjacent to said identified at least one term are retrieved. Said retrieved further terms may for instance represent a super or a subclass of the identified at least one term corresponding to one of the terms being comprised in the patient record. As a result, additional information, being modelled in the textual resource is retrieved for a circumscription of terms being comprised in the patient record.

In an embodiment of the method, the step of identifying at least one term comprises identifying at least one correspondence of said at least one term being comprised in the textual resource and said term being comprised in the patient record. This may have the advantage that the step of identifying at least one correspondence can be accomplished according to any predefined metric. The metric may define constraints, which have to be fulfilled by the terms for considering them as corresponding terms.

In an embodiment of the method, identifying at least one correspondence is accomplished as a function of an evaluation of at least one of a group of relations between said terms, the group of relations comprising: equality, synonymy, at least one common super class and at least one common subclass. This has the advantage that a correspondence of terms is evaluated according to metrics considering also ontology related concepts, such as class hierarchies.

In an embodiment of the method, the step of identifying at least one term and the step of retrieving further terms are accomplished in a first iteration and in a second iteration and the further terms retrieved in a first iteration are compared with the further terms retrieved in the second iteration. This may hold the advantage that additional information regarding several terms of a patient record is identified. Hence, dependencies between said terms being comprised in the patient record are identified.

In an embodiment of the method a dependency between a first patient record and a second patient record is identified as a function of said comparison. This may hold the advantage that analogue patterns between several patient records can be identified. This helps to predict for instance the course of a disease.

In an embodiment of the method a dependency between a first part of a patient record and a second part of said same patient record is identified as a function of said comparison. This has the advantage that parts within one single patient record can be compared under consideration of additional information. For instance, a patient may show two symptoms which might be caused by the same disease. Starting from the two symptoms, one may discover that the single disease is responsible for both of the symptoms.

In an embodiment of the method the retrieved further terms are structured according to at least one of a group of structuring techniques, the group of structuring techniques comprising: a faceted classification, a hierarchical classification and a clustering. This has the advantage that several techniques can be applied for conditioning the retrieved additional information. This serves also as a preparing step regarding a visualization of retrieved additional information.

In an embodiment of the method the structuring of the retrieved further terms allows performing at least one of a group of actions on said retrieved further terms, the group of actions comprising: a faceted browsing, a faceted search, a faceted navigation and a navigation in a tree-like structure. This has the advantage that the retrieved additional information can be intuitively and easily searched and hence understood also by persons which do not hold advanced knowledge regarding data processing such as clinical experts.

In an embodiment of the method, the retrieved further terms are visualized as a function of at least one provided visualization parameter. This has the advantage that the retrieved additional information can be presented to a user, for example clinical staff, according to configurable parameters.

In an embodiment of the method the steps of providing the textual resource and providing the patient record comprise an adaptation of at least one data format. This has the advantage that heterogeneous data sources may be used for provision of the textual resource and for provision of the patient record.

In an embodiment of the method, a textual resource is formed by at least one of a group of resources, the group of resources comprising: a taxonomy, a thesaurus, an ontology, a full text, a dictionary, a set of keywords, a lexicon, a website and an encyclopaedia. This has the advantage that several predefined knowledge basis may be considered by the provision of the textual resource.

The inventors further propose an apparatus for retrieval of additional information regarding a patient record, especially for accomplishing at least one of the aforementioned methods, said apparatus comprising:
a device for providing a textual resource, the textual resource comprising at least one term and at least one relationship between said terms;
a device for providing the patient record, the patient record comprising at least one term;
a device for identifying at least one term being comprised in the textual resource, which corresponds to a term being comprised in the patient record; and
a device for retrieving further terms being comprised in the textual resource, said further terms holding at least one of said relationships with said at least one identified term being comprised in said textual resource.

In an embodiment of the apparatus the device for providing the textual resource, the device for providing the patient record, the device for identifying at least one term and the device for retrieving further terms are formed by a calculation unit. This has the advantage that at least one of the devices can be formed by a microprocessor, being arranged to perform a variety of different tasks.

The inventors furthermore propose a computer for retrieval of additional information regarding a patient record, especially for accomplishing one of the aforementioned methods, said computer comprising:
a memory unit for provision of a textual resource, the textual resource comprising at least one term and at least one relationship between said terms;
a memory unit for provision of the patient record, the patient record comprising at least one term; and
a calculation unit for identification of at least one term being comprised in the textual resource, which corresponds to a term being comprised in the patient record and
for retrieval of further terms being comprised in the textual resource, said further terms holding at least one of said relationships with said at least one identified term being comprised in said textual resource.

In an embodiment of the computer, the memory unit for provision of the textual resource and the memory unit for provision of the patient record are formed by one memory unit. This has the advantage that a single memory unit, for instance a data base server can be applied for provision of both, the textual resource and the patient record.

The inventors further propose a computer program being adapted to perform the aforementioned method on a computer.

The inventors furthermore propose a data carrier which stores the aforementioned computer program.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a block diagram of a possible embodiment of an apparatus for retrieval of additional information according to an aspect of the proposed method and apparatus;

FIG. 2 shows a detailed block diagram of a possible embodiment of an apparatus for retrieval of additional information;

FIG. 3 shows an identification of a relationship between one term being comprised in the textual resource and one term being comprised in the patient record;

FIG. 4 shows a block diagram of an embodiment of an apparatus for retrieval of additional information;

FIG. 5 shows an illustration of a method for retrieving additional information;

FIG. 6 shows a flow diagram of a method for retrieving additional information; and

FIG. 7 shows a detailed flow diagram of a method for retrieving additional information.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

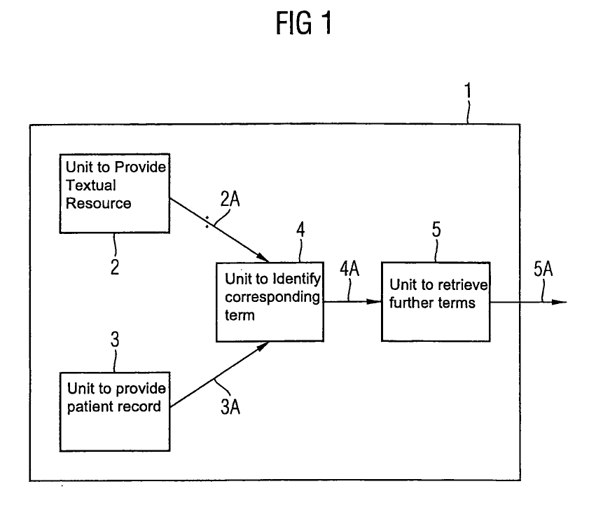

FIG. 1 shows a block diagram of an apparatus 1 for retrieval of additional information regarding a patient record according to an embodiment of the proposed method and apparatus, and comprises a unit 2 for providing a textual resource 2A, the textual resource 2A comprising at least one term and at least one relationship between said terms, a unit 3 for providing the patient record 3A, the patient record 3A comprising at least one term, a unit 4 for identifying at least one term 4A being comprised in the textual resource 2A, which corresponds to a term being comprised in the patient record 3A and a unit 5 for retrieving further terms 5A being comprised in a textual resource 2A, said further terms 5A holding at least one of said relationships, said at least one identified term 4A being comprised and said textual resource 2A.

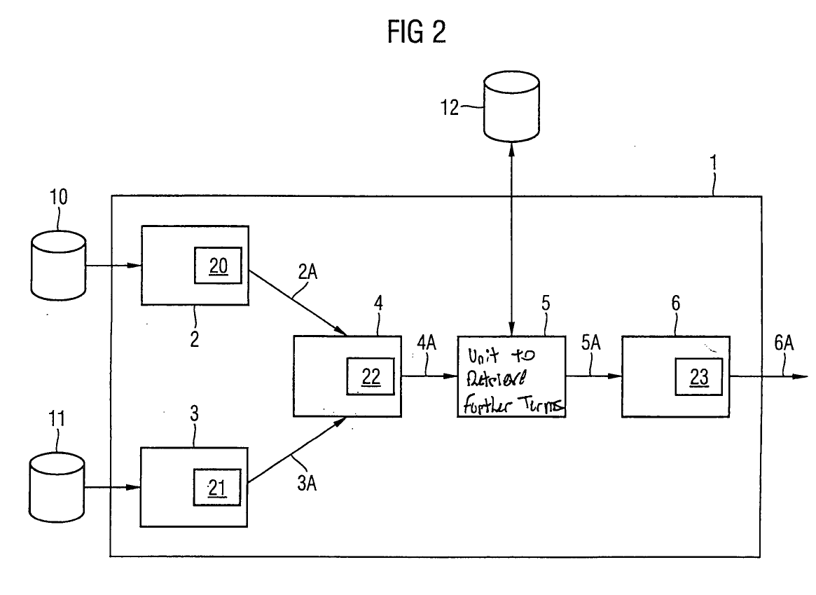

FIG. 2 shows a detailed block diagram of an apparatus 1 for retrieval of additional information regarding a patient record 3A, according to the inventors' proposal, and differs from the apparatus 1, as shown in FIG. 1 as follows:
The unit 2 for providing a textual resource 2A communicates with a memory device 10. The memory device 10 comprises the textual resource and can comprise further meta information regarding the textual resource. Meta information may for instance provide information about the author, a version and or a time stamp referring to the creation of the textual resource 2A. The unit 2 for providing the textual resource 2A provides the textual resource 2A as a function of at least one look-up in the memory device 10. The memory device 10 can also provide several textual resources, which may be combined forming one textual resource 2A. In a possible embodiment this is accomplished under usage of an abstraction layer. Said textual resources can be a FMA ontology and a WHO-classification. Those textual resources can be accessed over an integration layer.

Textual resources can be stored in different data formats and according to different data structures. Therefore, a data integration device 20 is arranged to transform the data provided by the memory device 10 into a specified data format and/or into a specified data structure. The textual resource 2A is transmitted to the unit 4 for identifying at least one term 4A.

The unit 3 for providing the patient record 3A communicates with a memory device 11. The memory device 11 provides the unit 4 for identifying at least one term 4A with at least one patient record 3A. The memory device 11 may store several patient records. Several patient records can be stored in one data base and/or one table. Such a table comprises several data sets, each data set referring to one patient. An example for patient data is provided in the following:

| | Sex | Age at Diagnosis | . . . | Tumour Site | . . . |
|---|---|---|---|---|---|
| patient1 | M | | . . . | Cerebellum | . . . |
| patient2 | F | | . . . | Hypothalamus | . . . |
| . . . | . . . | . . . | . . . | . . . | . . . |

The unit 4 for identifying at least one term 4A may comprise a reasoning device 22, which is arranged to identify a correspondence between two terms. The reasoning device 22 compares the textual resource and the patient record 3A. The comparison is performed in a possible embodiment as a function of a dictionary holding corresponding terms. A correspondence of terms can also be identified as a function of a synonymy relation. Further metrics for evaluation of corresponding terms consider super and/or subclass relations. For instance in a first ontology a concept holds a certain number of classes, then one concept modelled in a second ontology corresponds to said first concept in case that second concept holds the same subclasses as the first concept. The identification of corresponding terms is not limited to the above mentioned examples.

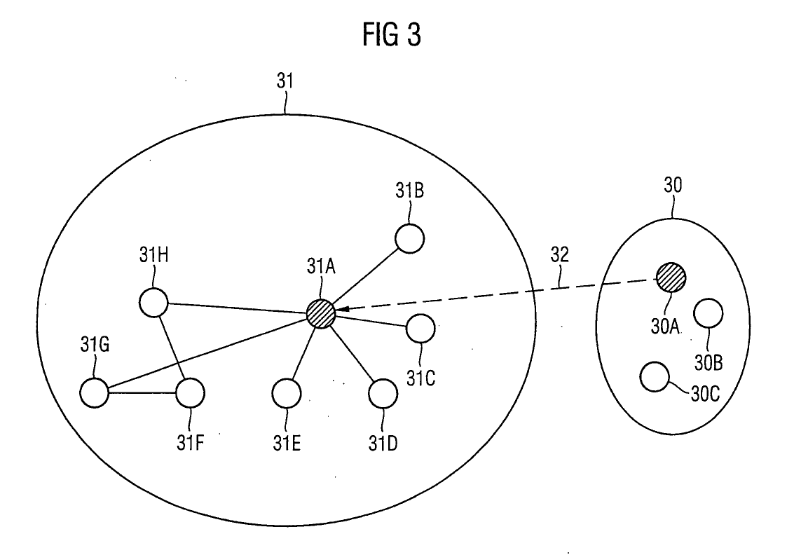

The identified at least one term 4A is transmitted to a unit 5 for retrieving further terms 5A. The unit 5 communicates with a memory device 12. The memory device 12 and the memory device 10 can be formed by a single memory device. The memory device 12 also stores an ontology which holds the identified at least one term 4A and additional terms forming a context of said at least one term 4A. Said context can be formed by relationships between said terms. The memory device 12 stores for instance an ontology of the health care domain. Such an ontology may for instance be the FMA ontology and/or the WHO-classification. More detailed example of the ontology stored in the memory device 12 is given in FIG. 3.

The retrieved further terms 5A are transmitted to an optional structuring device 6. Said structuring device 6 is arranged to structure the other terms 5A according to a predefined parameter. Said structured, retrieved further terms 5A may for instance be browsed by an ontology-based facet browser. In a further optional device, namely the visualization device 23 the retrieved further terms 5A are visualized and presented to the user. The visualization 6A allows a person without advanced knowledge in data processing, such as a clinical expert, for intuitively understanding of the additional information regarding a patient record.

FIG. 3 shows an illustration of a specific patient record 30 and a domain specific ontology 31 of the health care sector. Said specific patient record 30 correspond to the patient record 2A. The ontology 31 forms an embodiment of the textual resource 3A. The relationship 32 connects a term 30A being comprised in the patient record 30 and a term 31A being comprised in the ontology 31.

In the present embodiment the patient record 30 comprises the term “tumour” as term 30A, the term “age at diagnosis” as term 30B and “a patient ID” as term 30C. In the present embodiment the clinical expert examines a patient and studies the respective patient record 30. From the patient record 30 it is known that the patient suffers a tumour. This is recognized by term 30A. The clinical expert requires further information about the tumour. The apparatus 1 as described in FIG. 2 is able to identify that the ontology 31 comprises a term 31A, namely “tumour site”. The correspondence has been identified, as the term “tumour site” and the term “tumour” hold a minimal string distance, as compared with the string distance of term 30A and respectively terms 31A, 31B, 31C, 31D, 31E, 31F, 31G and 31H. Hence, the terms 30A and 31A are corresponding terms.

In the present embodiment the apparatus 1 is further arranged to evaluate relationships which connect for instance terms 31A and 31E, as well as terms 31A and term 31D. Hence, it can be recognized that the term “cerebellum” 31E and the term “hypothalamus” 31D has an relationship with “tumour site” 31A. Hence, the apparatus 1, has identified that in case a patient suffers a tumour, the tumour can have several tumour sites. A tumour site may for instance be cerebellum or hypothalamus.

The procedure as proposed, may be performed accordingly on several other patient's records, for instance, the patient record 30′. The apparatus 1 is arranged to identify dependencies between the patient record 30 and the patient record 30′. Hence, the discovery of patents and dependencies in patient data is accomplished. For example, establishing a correlation between the attributes “quality of life” and “tumour location” of similar patients, is a routine task for clinicians. Therefore, the visualisation 6A of correlations between selected patient attributes becomes crucial in the clinical decision making process. Patient data attributes, such as the terms 30A, 30B and 30C, may provide different levels of detail and precision. For example a tumour location can be specified as “cerebral hemisphere” or more detailed as “frontal left cerebral hemisphere”.

An iterative accomplishing of retrieving additional information regarding several patient records 30, a comparison of similar patient records with regard to relevant patient attributes can be accomplished by the apparatus 1.

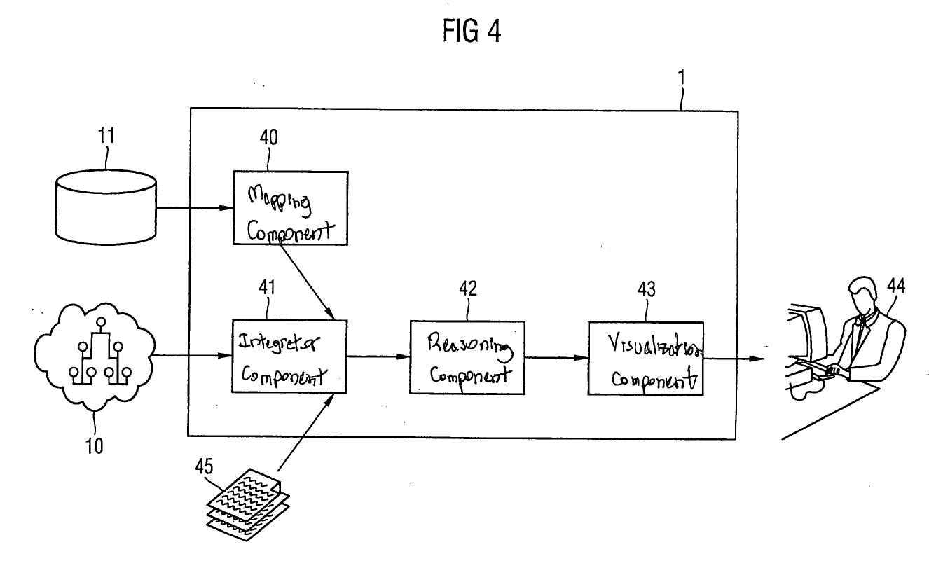

FIG. 4 shows a block diagram of an apparatus 1 for retrieval of additional information.

In the shown embodiment the apparatus 1 comprises a DB/OWL DL mapping component 40. The DB/OWL DL mapping component 40 creates simple views on patient data from the data base and maps them to the representation format OWL-DL. The DB/OWL DL mapping component 40 uses semantic annotations of the patient's data to expose patient's information as an OWL-DL ontology. In a first step, a flat view is created from the relevant relations which includes the entity identifiers, also referred to as patient ID, the concept URIs for the hierarchical classification, also referred to as tumour location and additional rules, for example status at the end of the treatment in later examples, which are of interest but do not contribute to the reasoning. In a subsequent step the relevant columns of the relation are translated into description logics, which may be expressed in OWL. This is implemented using a Mapper class, which is governed by the patient terminology and a set of mapping descriptions, which bridge the relational and description logics schema. When browsing along multiple axis is required, they are included in the OWL view.

The apparatus 1 furthermore comprises an OWL-DL integrator component 41. The OWL-DL integrator component 41 may be a generalized OWL ontology manager, which is responsible for importing and managing all the ontology components and loading the knowledge into a reasoner. The OWL-DL integrator component 41 can implement multiple ways of accumulating knowledge, including loading OWL from external URI, loading instance data from the data base using Mapper instances and adding standalone axioms on the fly. It populates the reasoner with the merged external, patient and classification ontologies and initializes the reasoning.

The apparatus 1 furthermore comprises a reasoning component 41. The reasoning component 42 uses the set of assertions and knowledge accumulated and answers semantic queries, and in particular it creates the inferred patient classification. The reasoning component 41 hence creates the inferred hierarchical classification of patients. The transitive regional part of property on anatomical concepts induces the subsumption relationship on patient classes.

The apparatus 1 further comprises an interpretation and visualisation component 43. This component maps the inferred classification from OWL to the appropriate representation of the user interface. It can also add further attributes from the database, which was not considered in the reasoning process.

The retrieved visual information may be provided to a clinical expert 44.

The apparatus 1 furthermore communicates with a memory device, which provides query axioms 45. The queries 45 may also be input by a user.

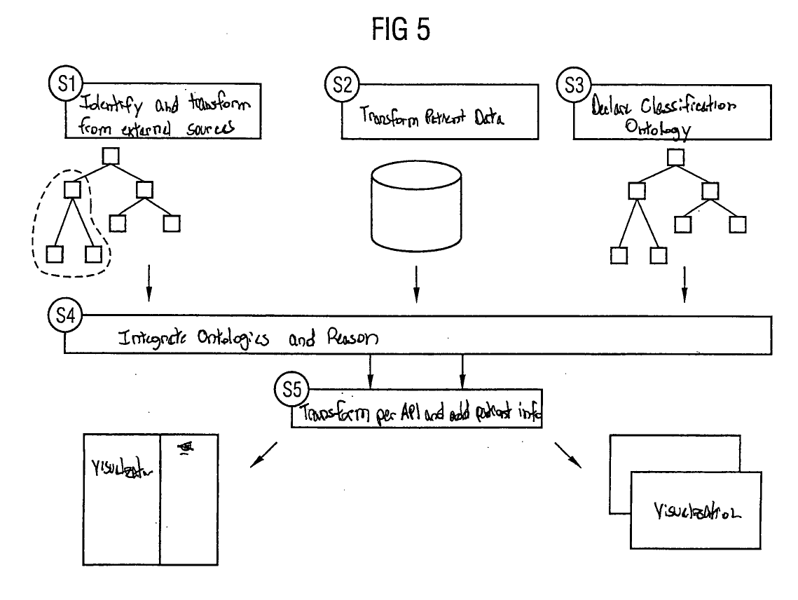

FIG. 5 shows an illustration of a method for retrieving additional information.

In a first step 51, suitable fragments of external knowledge sources, such as the FMA ontology or the WHO classification are identified and transformed to the OWL-DL representation. These fragments encompass all concepts and associations needed for a visualisation task, for instance the visualisation of brain tumour patient records. In the present embodiment the FMA fragment covers the regional -part-of-hierarchy of brain regions and the WHO classification of tumours of the nervous system as relevant medical background knowledge.

In a second step 52, patient data is transformed into the OWL-DL representation. Emanating from a at database view of the patient data covering a set of selected attributes, a description logic representation of the knowledge that contributes to the inference is created.

In a third step 53, the classification ontology is declared, which lists the definitions of patient sets required for the visualisation. The simple ontology also provides the necessary alignment between the external knowledge and the patient ontology. The classification ontology includes a set of defined classes capturing all patient attributes, such as tumour location, WHO grade or WHO classification that are governing the classification process.

In a fourth step 54 an integration of the three ontologies and the reasoning process is accomplished. The result of the reasoning process is the inferred hierarchy of patient classes and the inferred class membership of the individual patients.

In a fifth step 55 the inferred model is used for deploying it onto the visualisation component. This includes transforming the OWL-DL representation to the format conformant to the required API and inclusion of patient attributes not contributing to the reasoning process, directly from the patient database.

At least one of the aforementioned steps can be performed iteratively and/or in a different order.

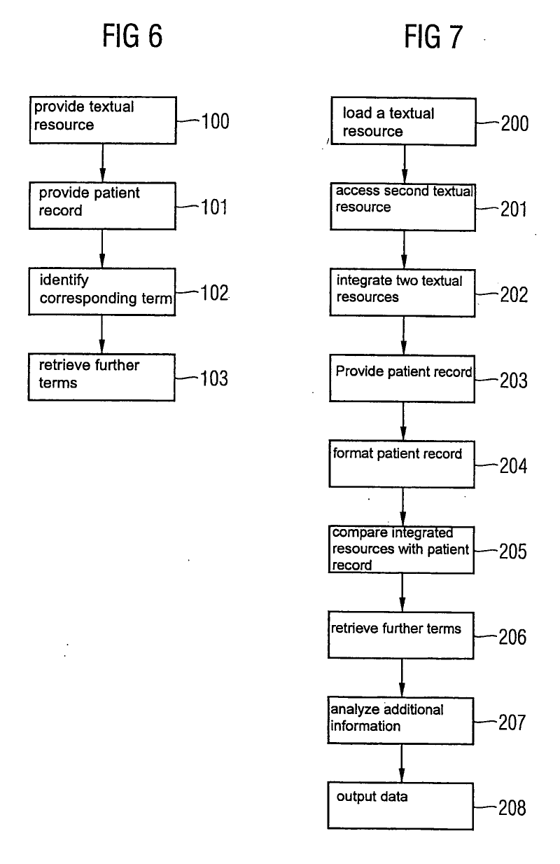

FIG. 6 shows a flow diagram of a method for retrieving additional information and comprises the steps of:
providing 100 a textual resource 2A, the textual resource 2A comprising at least one term and at least one relationship between said terms;
providing 101 the patient record 3A, the patient record 3A comprising at least one term;
identifying 102 at least one term 4A being comprised in the textual resource 2A, which corresponds to a term being comprised in the patient record 3A; and
retrieving 103 further terms 5A being comprised in the textual resource 2A, said further terms 5A holding at least one of said relationships with said at least one identified term 4A being comprised in said textual resource 2A.

At least one of the aforementioned steps can be performed iteratively and/or in a different order.

FIG. 7 shows a flow diagram of a method for retrieving additional information according to an embodiment and comprises the following steps:
In a first step 200 a textual resource 2A is loaded from a memory device 10. In a further subsequent step 201 a second textual resource is accessed from the memory device 10. The first textual resource, as provided in step 200 may be the FMA ontology. The second textual resource as provided in step 201 may be the WHO classification.
In a subsequent step 202 the two textual resources provided in step 200 and step 201 are integrated into a single ontology. The step 202 may further comprise substeps such as an adaptation of the format of the ontology. The integration as provided in step 202 may be implemented as an integration layer.
In a subsequent step 203 at least one patient record 3A is provided. The patient record 3A holds information about a diagnosis of a patient.
In a subsequent, optional step 204 the data of the patient record 3A is formatted into a predefined data format.
In a subsequent step 205 the ontology as provided in the step 202 and the patient record 3A, as provided in the step 203 are compared regarding correspondences between terms of said ontology and said patient records 3A.
In a subsequent step 206 further terms, which are related to at least one term identified in step 205 are retrieved. The retrieval may be accomplished by reasoning, and/or an analysis of the ontology as provided in step 202.
The steps 200 to 206 may be performed iteratively, which results in a provision of additional information regarding several patient records.
Hence, in an optional step 207 an analysis of the additional information as provided by each of the iterations of steps 200 to step 206 is accomplished. Hence, in step 207 dependencies between several patient records of several patients can be identified. Clinical experts can gain knowledge from said dependencies between said patient records. For instance, several patient records can be compared regarding success of specific treatments.
In a subsequent step 208 the calculated data, such as the additional information regarding at least one patient record 3A, as well as the dependencies identified in step 207 are presented to the clinical expert. A step 208 may comprise further substeps, which are required for visualisation of the output data. This may comprise providing a data format being suitable for faceted browsing or for browsing the additional information in a tree-like structure.

At least one of the aforementioned steps can be performed iteratively and/or in a different order.

The embodiments can be implemented in computing hardware (computing apparatus) and/or software, such as (in a non-limiting example) any computer that can store, retrieve, process and/or output data and/or communicate with other computers. The processes can also be distributed via, for example, downloading over a network such as the Internet. The results produced can be output to a display device, printer, readily accessible memory or another computer on a network. A program/software implementing the embodiments may be recorded on computer-readable media comprising computer-readable recording media. The program/software implementing the embodiments may also be transmitted over a transmission communication media such as a carrier wave. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method of retrieving additional information regarding a patient record, said method comprising:
providing a textual resource from a first memory unit, the textual resource including at least one term and at least one relationship between said at least one term and at least one other term;
providing the patient record from a second memory unit, the patient record including at least one term;
identifying at least one term included in said textual resource corresponding to at least one term included in the patient record at a calculation unit; and
retrieving further terms included in the textual resource, said further terms having at least one relationship with said at least one identified term included in said textual resource.

2. The method according to claim 1, wherein the identifying at least one term includes identifying at least one correspondence of said at least one term included in the textual resource and said at least one term included in the patient record.

3. The method according to claim 2, wherein the identifying at least one correspondence is accomplished as a function of an evaluation of at least one of a group of relations between said terms, the group of relations including equality, synonymy, at least one common superclass and at least one common subclass.

4. The method according to claim 1, wherein the identifying at least one term and the retrieving further terms are accomplished in a first iteration and in a second iteration and the further terms retrieved in the first iteration are compared with the further terms retrieved in the second iteration.

5. The method according to claim 4, wherein a dependency between a first patient record and a second patient record is identified as a function of said comparison.

6. The method according to claim 4, wherein a dependency between a first part of a patient record and a second part of said same patient record is identified as a function of said comparison.

7. The method according to claim 1, wherein the retrieved further terms are structured according to at least one of a group of structuring techniques, the group of structuring techniques including a faceted classification, a hierarchical classification and a clustering.

8. The method according to claim 7, wherein the structuring of the retrieved further terms allows performing at least one of a group of actions on said retrieved further terms, the group of actions including a faceted browsing, a faceted search, a faceted navigation and a tree-like navigation.

9. The method according to claim 1, wherein the retrieved further terms are visualized as a function of at least one provided visualization parameter.

10. The method according to claim 1, wherein the providing the textual resource and the providing the patient record include an adaptation of at least one data format.

11. The method of claim 1, wherein a textual resource is formed by at least one of a group of resources, the group of resources including a taxonomy, a thesaurus, an ontology, a full text, a dictionary, a set of keywords, a lexicon, a website and an encyclopaedia.

12. An apparatus for retrieval of additional information regarding a patient record, said apparatus comprising:
means for providing a textual resource, the textual resource including at least one term and at least one relationship between said at least one term and at least one other term;
means for providing the patient record, the patient record including at least one term;
means for identifying at least one term included in the textual resource corresponding to at least one term included in the patient record; and
means for retrieving further terms included in the textual resource, said further terms having at least one relationship with said at least one identified term included in said textual resource.

13. The apparatus according to claim 12, wherein the means for providing the textual resource, the means for providing the patient record, the means for identifying at least one term and the means for retrieving further terms are formed by one calculation unit.

14. A computer for retrieval of additional information regarding a patient record, the computer comprising:
a memory unit storing a textual resource, the textual resource including at least one term and at least one relationship between said at least one term and at least one other term;
a memory unit storing the patient record, the patient record including at least one term; and
at least one calculation unit identifying at least one term included in the textual resource corresponding to at least one term included in the patient record and retrieving further terms included in the textual resource, said further terms having at least one relationship with said at least one identified term included in said textual resource.

15. The computer according to claim 14, wherein the memory unit storing the textual resource and the memory unit storing the patient record are formed by one memory unit.

16. A computer program being adapted to cause a computer to perform the method of claim 1.

17. A data storage carrier which stores a computer program to cause a computer to perform the method of claim 1.

18. The method according to claim 1, wherein the first memory unit and the second memory unit are formed by one memory unit.
